(19) United States
(12) Patent Application Publication
(10) Pub. No.: US 2011/0252249 A1
(43) Pub. Date: Oct. 13, 2011

(54) METHOD OF POWER SUPPLY FOR GRAPHICS CARDS

(75) Inventors: Junxiong Wang, Shenzhen (CN); Tao Zhang, Shenzhen (CN)

(73) Assignee: NVIDIA Corporation, Santa Clara, CA (US)

(21) Appl. No.: 13/083,475

(22) Filed: Apr. 8, 2011

(30) Foreign Application Priority Data
Apr. 8, 2010 (CN) 201010141972.4

(51) Int. Cl. G06F 1/26

(52) U.S. Cl. 713/300

(57) ABSTRACT

The present invention provides a method of providing power supply for graphics cards. The method according to present invention comprises making graphics cards obtain power supply from outside computer chassis. The method and devices according to present invention can resolve the issue of high cost of upgrading graphics cards to high-end graphics cards or setting new computers with high-end graphics cards. It can efficiently reduce cost of using high-end graphics cards, develop potential of high-end graphics cards to the full and bring economic benefits for the users.

### CLAIM OF PRIORITY

The present application claims the priority of Chinese Patent Application No. 201010141972.4, filed Apr. 8, 2010, which is incorporated herein by reference.

### FIELD OF INVENTION

The present invention relates to computer hardware technology, and more particularly to a method of power supply for graphics cards.

### BACKGROUND

The update speed of computer hardware becomes faster and faster with the rapid development of computer technology. Users have more needs on computer hardware performance. Users can upgrade computer hardware to improve the computer performance with lower cost.

As the performance of playing videos, games and graphic presentation by computers depends on the image processing capability of the computer, a graphics card is a critical factor to determine whether a computer has a powerful image processing capability. Without a high-end graphics card with high engine clock, large memory capacity and high memory speed users can hardly obtain a powerful image processing capability. At the same time, performances of CPU, memory and other hardware in a computer do not influence the image processing capability of the computer much. In other words, the computer performance can be significantly improved by upgrading the graphics card with a high-end graphics card without changing any other hardware.

FIG. 1 shows a structural drawing of a high-end graphics card. A GPU 102 and other chips on a graphics card board 101 get power supply which they need through a power port 103, as shown in FIG. 1. It should be noted that the other chips than GPU 102 aren't shown for the purpose of conciseness. GPU 102 communicates with a computer through a PCI (Peripheral Component Interconnect) port 105. It should be noted that some high-end graphics cards also obtain power supply from PCI port 105 but lower-end graphics cards obtain power supply only from PCI port 105. Gal 102 generates video signal and outputs signal through video port 104 on the bracket 106. Usually, the power supply port 103 for High-end graphics cards is not arranged on bracket 106, but on the board area 101 of the graphics card, which is inside the chassis of the computer in order to make the connection of power supply inside the chassis easy and convenient.

High-end graphics cards have high power consumption and are usually greater than 600 W, so power from PCI slot can not meet need of high-end graphics cards. Because of this, there would be two problems when users upgrade their graphics cards: (1) Because of the power which PCI slot provides can not meet the need of high-end graphics cards on power consumption, users need to upgrade their main boards of computers and cost of upgrading main boards is relatively very high, the cost of upgrading main boards for using high-end graphics cards is nearly equal to 30% of cost of assembling a new computer. (2) If users do not want to upgrade their main boards of computers, they need to use power supply inside computer chassis to meet the need of high-end graphics cards on power consumption. But power which common power supply inside computer chassis provides is less or near the power which high-end graphics cards need. For instance, one of high-end graphics cards whose engine clock is 725 MHz, memory clock is 4000 MHz needs a power supply inside computer chassis which can provide power above 650 W to achieve its full image processing capability potential. But common power supply inside computer chassis usually provides power about 350 W, which can not meet the need of high-end graphics cards on power consumption. So users need to upgrade power supply inside computer chassis (hey use and select a power supply inside computer chassis whose power is 650 W and cost is 6-10 times of cost of the 350 W power supply inside computer chassis. That means changing the power supply inside computer chassis also makes users undertake higher cost.

Furthermore, when users assemble new computers, because of high cost of power supply inside the computer chassis with high power, they need a method of using high-end graphics cards normally when they select 350 W power supply inside the computer chassis to reduce cost of arranging high-end graphics cards.

Consequently, problem demanding prompt solution is how to reduce cost of arranging high-end graphics cards.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, it is therefore an object of the present invention to provide a method of power supply for graphics cards and corresponding graphics card system. Thus, this method and system will resolve the issue of high cost of upgrading graphics cards to high-end graphics cards or assembling new computers with high-end graphics cards. It can efficiently reduce cost of arranging high-end graphics cards, develop potential of high-end graphics cards to the full and bring economic benefit for users.

The present invention provides a method of power supply for graphics cards. Such method comprises making graphics cards obtain power supply from outside computer chassis.

The present invention additionally provides a graphics card and a voltage converter for the graphics card for implementing the method above. A voltage converter converts an external power supply to power which the graphics card operates at, an input port of said voltage converter connects with an external power supply, output port of said voltage converter connects with a power port of graphics card, an output cable of said voltage converter passes through a hole on computer chassis or the bracket of the graphics card and connects with said power port of graphics card.

The present invention also additionally provides a graphics card and a voltage converter for the graphics card for implementing the method above. A power port of the graphics card is on bracket of said graphics card, said graphics card connects with a voltage converter.

The present invention also additionally provides a graphics card for implementing the method above. A power switching module, said power switching module coverts an external power supply to power which said graphics card need, position of an input port of said power switching module is on the bracket of the graphics card and connects to said external power supply and an output of said power switching module connects with said power port of said graphics card by a cable or wiring of said board of the graphics card.

Other features and embodiments are described below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a structural drawing of a high-end graphics card;

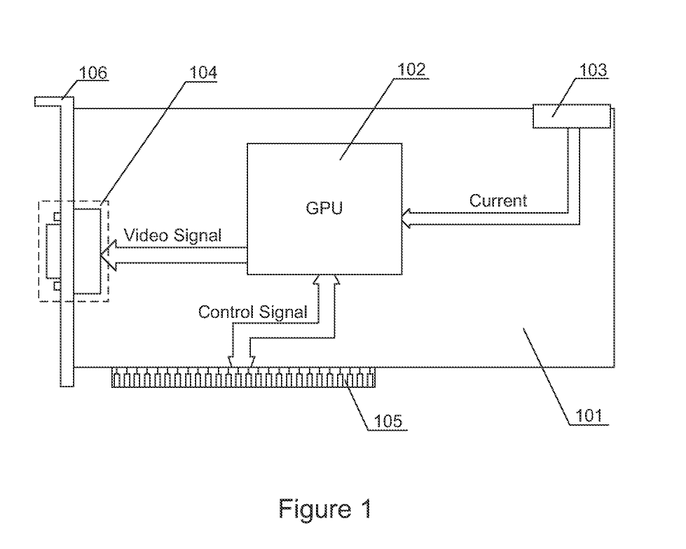

FIG. 2a is a graphics card power supply structural drawing illustrating a method of power supply for graphics cards according to one preferred embodiment of the present invention;

FIG. 2b is a graphics card power supply structural drawing illustrating a method of power supply for graphics cards according to one preferred embodiment of the present invention;

FIG. 2c is a graphics card power supply structural drawing illustrating a method of power supply for graphics cards according to one preferred embodiment of the present invention;

FIG. 2d is a graphics card power supply structural drawing illustrating a method of power supply for graphics cards according to one preferred embodiment of the present invention;

FIG. 2e is a voltage converter connection structural drawing illustrating a method of power supply for graphics cards according to one preferred embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, certain well-known features have not been described in order to avoid obscuring the present invention.

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying”, “accessing”, “writing”, “including”, “storing”, “transmitting”, “traversing”, “associating”, “identifying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

Portions of the detailed description that follows are presented and discussed in terms of a method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing”, “writing”, “including”, “storing”, “transmitting”, “traversing”, “associating”, “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RE, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

### EXEMPLARY EMBODIMENT 1

According to one embodiment of the present invention, in order to reduce the cost for install a high-end graphics card, a method of providing power supply for a graphics card is provided. The graphics card is arranged inside a computer chassis. The graphics card can obtain power supply from an external power supply which is arranged outside said computer chassis.

In this embodiment, graphics cards do not get power from PCI slot on the main board of a computer and the inner power supply inside the chassis, so as to reduce cost of setting high-end graphics cards. The graphics card can obtain power supply from an outer power supply outside the computer chassis. Therefore, the computer with 350 W or lower inner power supply inside the chassis is able to incorporate a high-end graphics card normally.

Specifically, there are two ways to make high-end graphics card obtain power supply from the power supply outside the computer chassis. One is to improve the existing computer chassis or the bracket of the graphics card, which means to open a hole through which the power supply cable can pass on the computer chassis or the bracket of the graphics card, and to select suitable power supply devices for the graphics card. Power supply cable passes through the hole on the improved computer chassis or the bracket of the graphics card, and then enters the computer chassis to connect to the power port of the graphics card, so the graphics card can obtain power supply from power supply device. For the selection of the outer power supply devices, a suitable power supply device should be selected according to the requirements of the power, voltage and current for operating the graphics card. To reduce the cost of setting a high-end graphics card, a separate voltage converter with low costs may be arranged to convert the power and output voltage from the external power supply to meet the requirements of the graphics card on power.

Another way is improving the bracket and circuit of the graphics card to make the graphics card obtain power supply from an external power supply device incorporating a voltage converter or an external power supply including a mains supply. For instance, when the graphics card obtains power supply through a voltage converter, there is a need for changing the location of the power port of the graphics card from the card board area inside the chassis to bracket of the graphic card, and arranging a port on the bracket, so the output of voltage converter connects to the power supply port of the graphics card, and then the graphics card may obtain power supply from the external power supply. When users don't use a voltage converter and make graphics card obtain power supply from an external power supply directly, there is no need to set a power module which converts the external power supply to the power what the graphics card needs. Herein, it is equivalent to that the voltage converter is integrated with a high-end graphics card. In this case, power module should be arranged on the board area of the graphics card which is near the bracket of the graphics card and set the location of a module port which connects to an external power supply on the bracket of the graphics card. Therefore, the graphics card can obtain power supply from the external power supply directly.

With the method according to the present embodiment, users can install a high-end graphics card for their existing computers and do not need to change the existing configuration of their computer hardware when upgrading the graphics card to a high-end graphics card. Users can also install high-end graphics cards in their computers which have only a low power supply inside the chassis. The cost of using high-end graphics cards can be reduced efficiently, which will bring the potential power of high-end graphics cards to the full and bring economic benefits for the users.

### EXEMPLARY EMBODIMENT 2

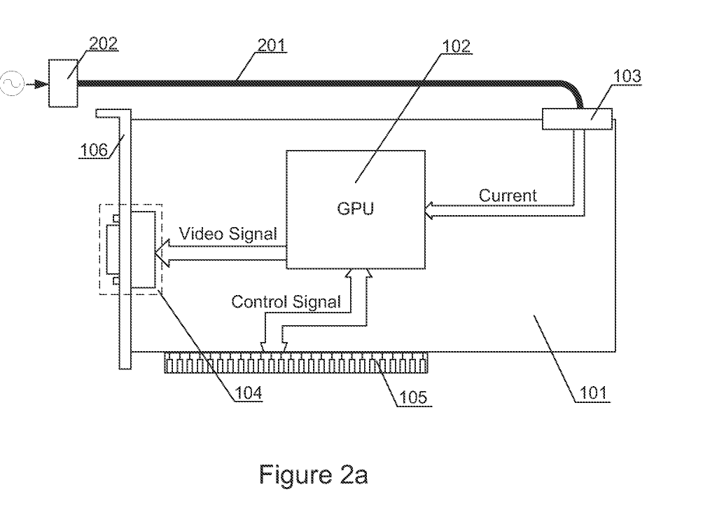

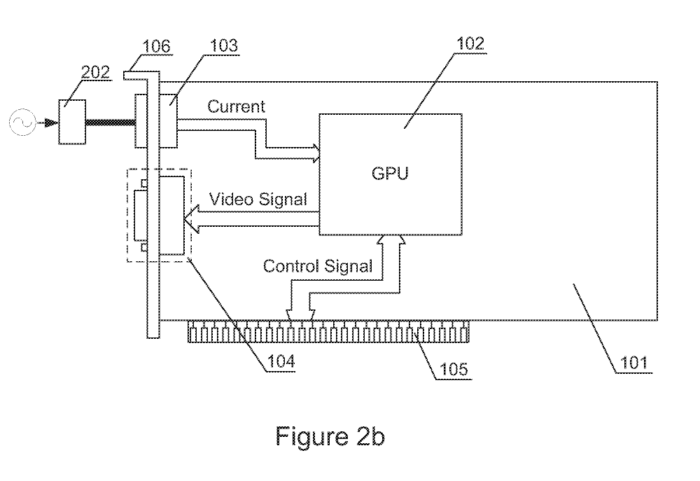

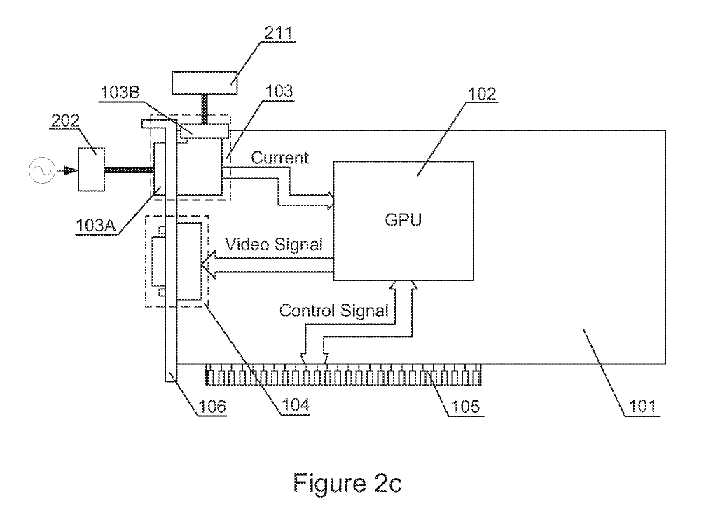

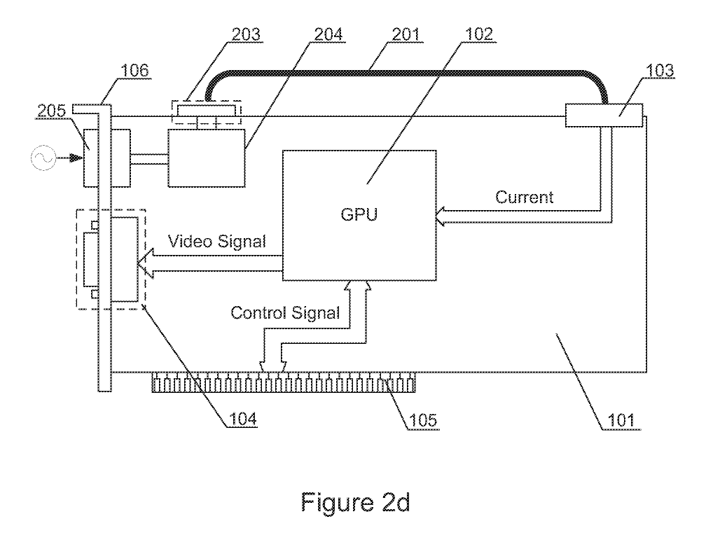

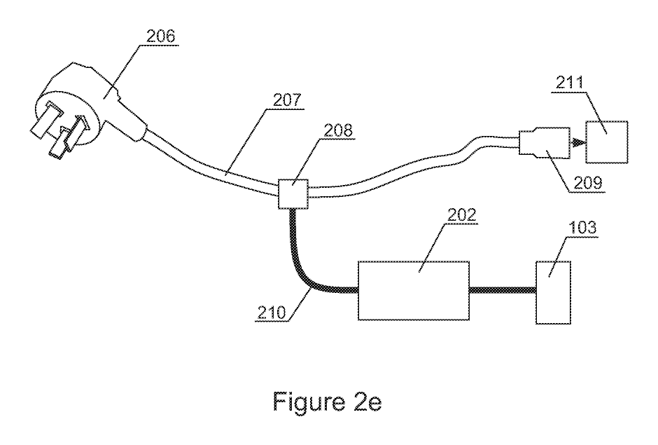

Referring next to FIG. 2a, shown is a graphics card power supply structural drawing illustrating using the method of power supply for graphics cards according to one preferred embodiment of the present invention. The graphics card power supply structural of this embodiment includes: Using a voltage converter 202 to convert an external power supply to power which a graphics card operates at and using a cable 201 to connect an output of the voltage converter 202 and a power port 103 of the graphics card.

Specifically, input of the voltage converter 202 connects to the external power supply directly and selection of the voltage converter 202 depends on power what a graphics card needs. The output of voltage converter 202 connects to the power port 103 of the graphics card on board by cable 201. The functional modules like GPU 102 on board of graphics card can obtain power, voltage and current by power port 103. There are two way to let graphics cards obtain power: One is using power port 103 to obtain power completely that means the graphics cards do not obtain any power by PCI port 105 on graphics card board 101; Another is using PCI port 105 on graphics card board 101 to obtain part power from PCI slot of main board and obtain balance power from power port 103 to meet need of graphics cards. It should be noted that external power supply can include a mains supply with the voltage of 110V-220V and other AC power supplies computer that users can use.

There is no need in the present embodiment to change the design of the existing computer chassis and graphics cards. Users who want to upgrade his old computer or buy a new computer can use the high-end graphics card when the power supply inside the chassis is about 350 W or lower. It can efficiently reduce the cost of using high-end graphics cards greatly and bring economic benefits for the users.

Alternatively, the cable which connects the voltage converter 202 and the power port 103 of the graphics card can pass through a hole on the computer chassis or the bracket 106 of the graphics card. The size and position of the hole depends on the diameter of the cable and the situation of the computer chassis or the bracket 106 of the graphics card.

### EXEMPLARY EMBODIMENT 3

Referring next to FIG. 2b, shown is a graphics card power supply structural drawing illustrating the method of providing power supply for graphics cards according to one preferred embodiment of the present invention. A power port 103 is arranged on the bracket of the graphics card 106. A voltage converter 202 converts the voltage output from an external power supply to the voltage which a graphics card operates at, and an output of the voltage converter 202 connects to a power port 103 of the graphics card.

Specifically, the present embodiment is different from embodiment 2 in that the position of power port 103 of the graphics card is changed. In the present embodiment, there is a need to set the position of the power port 103 of the graphics card on the bracket of the graphics card 106 to make connection of graphics card and power supply easily.

Furthermore, in case where there is a high power supply inside the chassis whose power is above 650 W and a power port 103 of the graphics card is arranged on the bracket 106 of the graphics card, a switch cable may be provided for the users to connect the high power supply inside the chassis and the power port 103 of the graphics card. In addition, the switch cable can pass through the hole arranged on the computer chassis or the bracket 106 of the graphics card.

### EXEMPLARY EMBODIMENT 4

Referring next to FIG. 2c, shown is a graphics card power supply structural drawing illustrating using the method of providing power supply for graphics cards according to one preferred embodiment of the present invention. A power port 103 of the graphics card is connected with the output of voltage converter 202 or a power supply with high power inside the chassis as required. In this case, the power port 103 of the graphics card includes a voltage converter port 103A on the bracket 106 of the graphics card, and a chassis power port 103B on the board area 101 of the graphics card which is inside the chassis. So the graphics card is connected with the output of voltage converter 202 through the chassis power port 103A, and with the power supply inside the chassis 211 through the voltage converter port 103B. Users can use the voltage converter 202 as a power supply for graphics cards when they use a 350 W common power supply inside the chassis, also they can use the power supply inside the chassis 211 as a power supply for graphics cards when they use a 650 W or higher power supply inside the chassis. The graphics card power supply structural present embodiment provides also applies to users have multi graphics cards. When a user sets two or more graphics cards for his computer to get powerful image processing capability, although user has high power supply inside the chassis, it still may not satisfy need of graphics cards. Using the graphics card power supply structural according to present embodiment can resolve this issue, and further reduce cost of user setting computer efficiently and make using of high-end graphics cards more convenient.

### EXEMPLARY EMBODIMENT 5

Referring next to FIG. 2d, shown is a graphics card power supply structural drawing illustrating using method of providing power supply for graphics cards according to one preferred embodiment of the present invention. The graphics card board 101 comprises a power switching module 204. The input port 205 of the power switching module 204 is on the bracket 106 and connects to an external power supply. The power switching module 204 converts the voltage output from the external power supply to the voltage which the graphics card operates at. The output of the power switching module 204 connects to a power port 103 of the graphics card through a cable 201.

In the present embodiment, the voltage converter 202 in exemplary embodiment 2 is integrated on the graphics card board 101. So users with a common low-power power supply inside the chassis like 350 W can also use high-end graphics cards to reduce cost as much as possible. Users with a high-power power supply inside the chassis like 650 W can also use high-end graphics cards normally. In the meantime, users can further improve the graphics cards to integrate the power port 103 of the graphics card and the power switching module 204. Therefore, there is no need for the graphics card to equip with a cable 201 which connects the power switching module 204 and the power port 103 of the graphics card, in order to save the board space of the graphics card. Alternatively, the live line and neutral line of the input cable 201 of voltage converter 202 connect with the live line and neutral line of power cord 207 respectively, and in turn to connect to an external power supply.

### EXEMPLARY EMBODIMENT 6

Referring next to FIG. 2e, shown is a voltage converter connection structural drawing illustrating using method of providing power supply for graphics cards according to one preferred embodiment of the present invention. An input cable 210 of voltage converter 202 is leaded out from a power cord 207 of the computer chassis.

Specifically, a power cord 207 connects with an external power supply by a 3-phase plug 206. An input cable 210 of voltage converter 202 is leaded out from the power cord 207 of the computer chassis through a distribution box 208, or leaded out from the power cord 207 directly. An output of the voltage converter 202 connects with power port 103 of the graphics card. In the meantime, a port 209 of power cord 207 connects with the inner power supply inside the chassis 211.

In case that an external power supply is used to providing power supply to graphics cards, users may forget to connect the voltage converter with the external power supply when they start up the computer. In this situation, users have to shut down their computers to re-connect the voltage converter, in order to prevent any damages to the graphics cards or main boards of computers. It will not only bring inconvenience for the users but also bring a risk of damaging graphics cards or main boards of computers. However, using the method of the present embodiment, users need not connect the voltage converter with the external power supply separately before starting up their computers. Users only need to connect the power cord of computer and the external power supply to provide power for the graphics card, which make the usage of high-end graphics cards more convenient and safer.

Similarly, the cable which connects the input port 205 of the power switching module 204 in exemplary embodiment 5 can be also leaded out from a power cord 207 in the same way as in the present embodiment, which makes the usage of high-end graphics cards more convenient and safer.

According to the present invention, users may use high-end graphics cards with common power supply inside the chassis like 350 W when upgrading their old computer or installing a new computer. Therefore, they need not to upgrade the existing computer power supply inside the chassis, main boards or other parts of the computer. The cost for using high-end graphics cards can be reduced efficiently, which bring the potential power of high-end graphics cards to the full and bring economic benefits for the users.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application to thereby enable others skilled in the art to best utilize the invention and various embodiments with various modifications as are suited to the particular use are contemplated. The scope of the invention is to be defined by the claims appended hereto and their equivalents.

What is claimed is:

1. A method of providing power supply for a graphics card, said graphics card is arranged inside a computer chassis, said method comprising step of:
making said graphics card obtain power supply from an external power supply which is arranged outside said computer chassis.

2. The method of claim 1, wherein a power port is arranged on the board of said graphics card, and a voltage converter connects with said power port to convert the voltage output from said external power supply to a voltage which said graphics card operates at through a cable.

3. The method of claim 2, wherein said cable passes through a hole arranged on said computer chassis or a bracket of said graphics card.

4. The method of claim 1, wherein a power port for said graphics card is arranged on a bracket of said graphics card, a voltage converter which converts the voltage output from said external power supply to a voltage which said graphics card operates at connects with said power port.

5. The method of claim 4, wherein said power port includes a first port to connect with said voltage converter and a second port to connect with an inner power supply inside said computer chassis.

6. The method of claim 1, wherein a voltage converter module is arranged on said graphics card to convert said external power supply to a voltage which said graphics card operates at.

7. The method of claim 2, wherein said external power supply comprises a mains sup fly with the voltage of 110V-220V.

8. The method of claim 2, wherein said voltage converter connects with the cable of said external power supply through a distribution box, and connects in turn with said external power supply.

9. The method of claim 2, wherein said voltage converter connects with the cable of said external power supply directly, and connects in turn with said external power supply.

10. A system providing power supply for a graphics card, comprising:
a graphics card, arranged inside a computer chassis, and
an external power supply, providing power supply for said graphics card;
wherein said external power supply is arranged outside said computer chassis.

11. The system of claim 10, wherein said system further comprises a voltage converter, said voltage converter converts the voltage output from said external power supply to the voltage which said graphics card operates at.

12. The system of claim 11, wherein said system further comprises a power port arranged on the board of said graphics card and said power port connects with an output of said voltage converter.

13. The system of claim 11, wherein a power port is arranged on the bracket of said graphics card, and said voltage converter connects with said power port to convert the voltage output from said external power supply to the voltage which said graphics card operates at.

14. The system of claim 13, wherein said power port includes a first port to connect with said voltage converter and a second port to connect with an inner power supply inside the computer chassis.

15. The system of claims 11, wherein said voltage converter connects with the cable of said external power supply through a distribution box or directly, and connects in turn with said external power supply.

16. The system of claim 10, wherein a voltage converter module is arranged on said graphics card to convert the voltage output from said external power supply to the voltage which said graphics card operates at.

17. The system of claim 16, wherein said voltage converter module connects with the cable of said external power supply through which the computer chassis connects, and connects in turn with said external power supply.

18. The system of claim 11, wherein said external power supply comprises a mains supply with the voltage of 110V-220V.

19. A graphics card, said graphic card being arranged inside a computer chassis, wherein said graphics card comprising a power supply port for obtaining power from an external power supply arranged outside said computer chassis.

20. The graphics card of claim 19, wherein said external power supply comprises a mains supply with the voltage of 110V-220V.
